(19) United States
(12) Patent Application Publication
(10) Pub. No.: US 2016/0062984 A1
(43) Pub. Date: Mar. 3, 2016

(54) DEVICES AND METHODS FOR DETERMINING A RECIPIENT FOR A MESSAGE

(71) Applicant: Lenovo (Singapore) Pte. Ltd., New Tech Park (SG)

(72) Inventors: Neal Robert Caliendo, JR., Raleigh, NC (US); Russell Speight VanBlon, Raleigh, NC (US); Arnold S. Weksler, Raleigh, NC (US)

(21) Appl. No.: 14/475,796

(22) Filed: Sep. 3, 2014

(51) Int. Cl. G06F 17/27; G06F 3/0484; G06F 17/21; H04L 12/58

(52) U.S. Cl. CPC G06F 17/2765; H04L 51/28; G06F 3/04842; G06F 17/21

(57) ABSTRACT

In one aspect, a device includes a processor, a touch-enabled display accessible to the processor, and a memory accessible to the processor. The memory bears instructions executable by the processor to receive first input pertaining to at least a first recipient to which a message is to be sent, receive second input pertaining to a body of the message, and parse at least a portion of the body of the message to determine, based on at least a portion of the body of the message, whether the first recipient is a correct recipient for the message.

### FIELD

The present application relates generally to devices and methods for determining at least one recipient for a message.

### BACKGROUND

When composing a message, users typically indicate a recipient for the message. However, often times an incorrect recipient is mistakenly input by a user and hence the message may be inadvertently sent to the incorrect recipient rather man an intended one. There are currently no adequate and/or cost-effective ways to address the foregoing.

### SUMMARY

Accordingly, in one aspect a device includes a processor, a touch-enabled display accessible to the processor, and a memory accessible to the processor. The memory bears instructions executable by the processor to receive first input pertaining to at least a first recipient to which a message is to be sent, receive second input pertaining to a body of the message, and parse at least a portion of the body of the message to determine, based on at least a portion of the body of the message, whether the first recipient is a correct recipient for the message.

In another aspect, a method includes analyzing at least a portion of a payload of a message which is at least partially composed at a device to determine at least one recipient, where the message is composed at least in part using a first user interface (UI) presented on a display of the device. The method also includes, based at least in part on the analysis, recommending the at least one recipient.

In still another aspect, an apparatus includes a first processor, a network adapter, and storage bearing instructions executable by a second processor for determining, based on at least a portion of a body of a message, whether a first recipient of the message is a proper recipient for the message. The first recipient is received from a user, and the determining whether the first recipient is a proper recipient at least in part is based on data accessible using the second processor. The first processor transfers the instructions over a network via the network adapter.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 is a block diagram of a network of devices in accordance with present principles;

FIGS. 3 and 4 are flow charts showing example algorithms in accordance with present principles;

FIG. 5 is an example data table in accordance with present principles; and

FIGS. 6-13 are example user interfaces (UI) in accordance with present principles.

### DETAILED DESCRIPTION

This disclosure relates generally to device-based information. With respect to any computer systems discussed herein, a system may include server and client components, connected over a network such that data may be exchanged between the client and server components. The client components may include one or more computing devices including televisions (e.g. smart TVs, Internet-enabled TVs), computers such as desktops, laptops and tablet computers, so-called convertible devices (e.g. having a tablet configuration and laptop configuration), and other mobile devices including smart phones. These client devices may employ, as non-limiting examples, operating systems from Apple, Google, or Microsoft. A Unix or similar such as Linux operating system may be used. These operating systems can execute one or more browsers such as a browser made by Microsoft or Google or Mozilla or other browser program that can access web applications hosted by the internet servers over a network such as the Internet, a local intranet, or a virtual private network.

As used herein, instructions refer to computer-implemented steps for processing information in the system. Instructions can be implemented in software, firmware or hardware; hence, illustrative components, blocks, modules, circuits, and steps are set forth in terms of their functionality.

A processor may be any conventional general purpose single- or multi-chip processor that can execute logic by means of various lines such as address lines, data lines, and control lines and registers and shift registers. Moreover, any logical blocks, modules, and circuits described herein can be implemented or performed, in addition to a general purpose processor, in or by a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

Any software and/or applications described by way of flow charts and/or user interfaces herein can include various sub-routines, procedures, etc. It is to be understood that logic divulged as being executed by e.g. a module can be redistributed to other software modules and/or combined together in a single module and/or made available in a shareable library.

Logic when implemented in software, can be written in an appropriate language such as but not limited to C# or C++, and can be stored on or transmitted through a computer-readable storage medium (e.g. that may not be a carrier wave) such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and twisted pair wires. Such connections may include wireless communication connections including infrared and radio.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together. A and C together, B and C together, and/or A, B, and C together, etc.

“A system having one or more of A, B, and C” (likewise “a system having one or more of A, B, or C” and “a system having one or more of A, B, C”) includes systems that have A alone, B alone, C alone, A and B together, A and C together, B and C together, and/or A, B, and C together, etc.

The term “circuit” or “circuitry” is used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions.

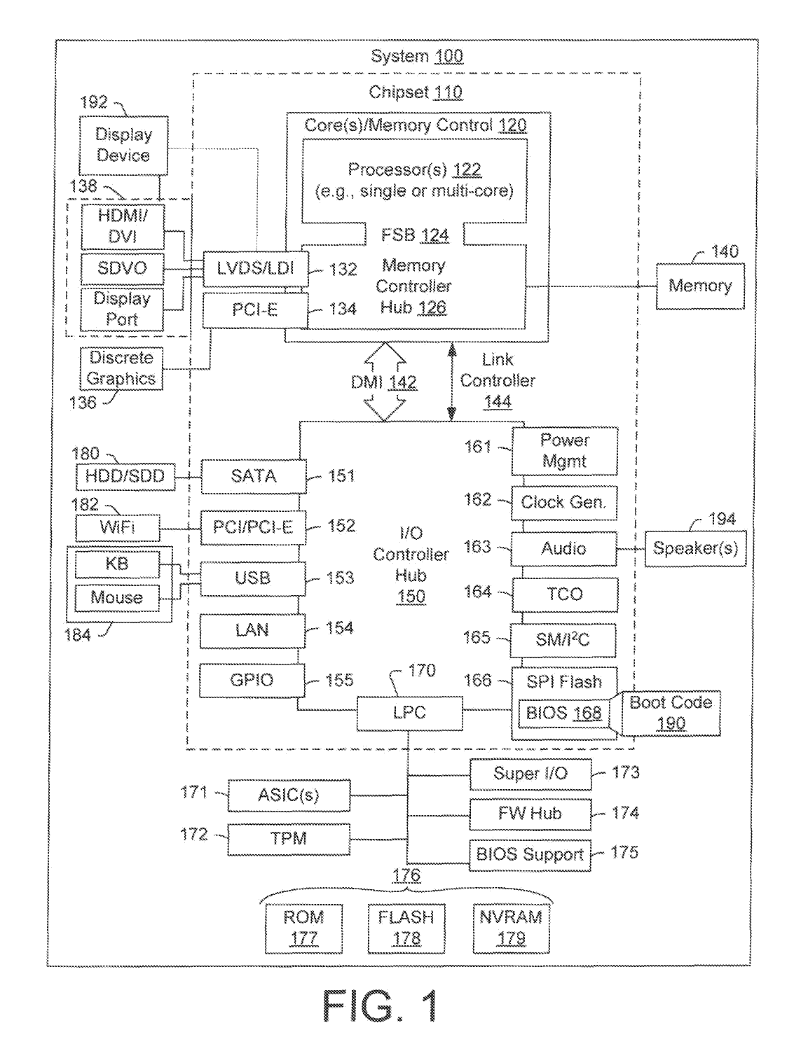

Now specifically in reference to FIG. 1, it shows an example block diagram of an information handling system and/or computer system 100. Note that in some embodiments the system 100 may be a desktop computer system, such as one of the ThinkCentre® or ThinkPad® series of personal computers sold by Lenovo (US) Inc. of Morrisville, N.C., or a workstation computer, such as the ThinkStation®, which are sold by Lenovo (US) Inc. of Morrisville, N.C.; however, as apparent from the description herein, a client device, a server or other machine in accordance with present principles may include other features or only some of the features of the system 100. Also, the system 100 may be e.g. a game console such as XBOX® or Playstation®.

As shown in FIG. 1, the system 100 includes a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link, between a “northbridge” and a “southbridge”).

The core and memory control group 120 include one or more processors 122 (e.g., single core or multi-core, etc.) and a memory controller hub 126 that exchange information via a front side bus (FSB) 124. As described herein, various components of the core and memory control group 120 may be integrated onto a single processor die, for example, to make a chip that supplants the conventional “northbridge” style architecture.

The memory controller hub 126 interfaces with memory 140. For example, the memory controller hub 126 may provide support for DDR SDRAM memory (e.g., DDR, DDR2, DDR3, etc). In general, the memory 140 is a type of random-access memory (RAM). It is often referred to as “system memory.”

The memory controller hub 126 further includes a low-voltage differential signaling interface (LVDS) 132. The LVDS 132 may be a so-called LVDS Display Interface (LDI) for support of a display device 192 (e.g., a CRT, a flat panel, a projector, a touch-enabled display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (x16) PCI-E port for an external PCI-E-based graphics card (including e.g. one of more GPUs). An example system may include AGP or PCI-E for support of graphics.

The I/O hub controller 150 includes a variety of interfaces. The example of FIG. 1 includes a SATA interface 151, one or more PCI-E interfaces 152 (optionally one or more legacy PCI interfaces), one or more USB interfaces 153, a LAN interface 154 (more generally a network interface for communication over at least one network such as the Internet, a WAN, a LAN, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes BIOS 168 and boot code 190. With respect to network connections, the I/O hub controller 150 may include integrated gigabit Ethernet controller lines multiplexed with a PCI-E interface port. Other network features may operate independent of a PCI-E interface.

The interfaces of the I/O hub controller 150 provide for communication with various devices, networks, etc. For example, the SATA interface 151 provides for reading, writing or reading and writing information on one or more drives 180 such as HDDs, SDDs or a combination thereof, but in any case the drives 180 are understood to be e.g. tangible computer readable storage mediums that may not be carrier waves. The I/O hub controller 150 may also include an advanced host controller interlace (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

Additionally, though now shown for clarity, in some embodiments the system 100 may include a gyroscope for e.g. sensing and/or measuring the orientation of the system 100 and providing input related thereto to the processor 122, an accelerometer for e.g. sensing acceleration and/or movement of the system 100 and providing input related thereto to the processor 122, an audio receiver/microphone providing input to the processor 122 e.g. based on a user providing audible input to the microphone, and a camera for gathering one or more images and providing input related thereto to the processor 122. The camera may be, e.g., a thermal imaging camera, a digital camera such as a webcam, and/or a camera integrated into the system 100 and controllable by the processor 122 to gather pictures/images and/or video. Still further, and also not shown for clarity, the system 100 may include a GPS transceiver that is configured to e.g. receive geographic position information from at least one satellite and provide the information to the processor 122. However, it is to be understood that another suitable position receiver other than a GPS receiver may be used in accordance with present principles to e.g. determine the location of the system 100.

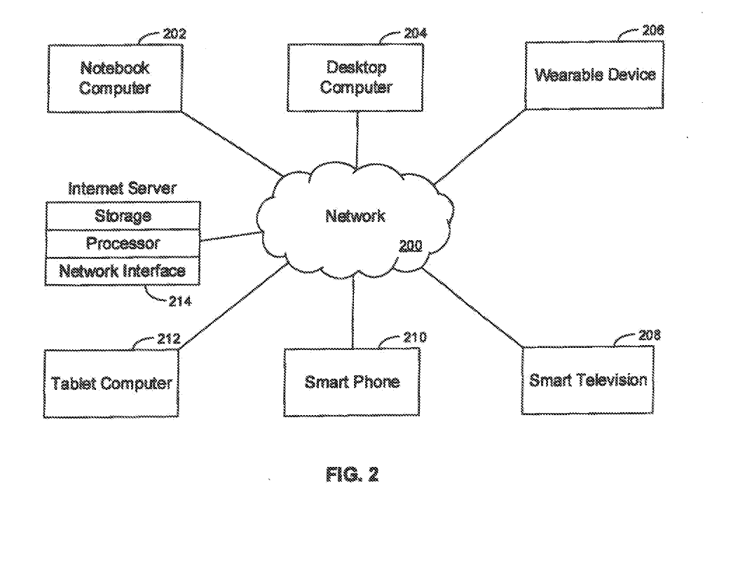

Before moving on to FIG. 2, it is to be understood that an example client device or other machine/computer may include fewer or more features than shown on the system 100 of FIG. 1. In any case, it is to be understood at least based on the foregoing that the system 100 is configured to undertake present principles.

Turning now to FIG. 2, it shows example devices communicating over a network 200 such as e.g. the Internet in accordance with present principles. It is to be understood that e.g. each of the devices described in reference to FIG. 2 may include at least some of the features, components, and/or elements of the system 100 described above. In any case, FIG. 2 shows a notebook computer 202, a desktop computer 204, a wearable device 206 such as e.g. a smart watch, a smart television (TV) 208, a smart phone 210, a tablet computer 212, and a server 214 in accordance with present principles such as e.g. an Internet server that may e.g. provide cloud storage accessible to the devices 202-212. It is to be understood that the devices 202-214 are configured to communicate with each other over the network 200 to undertake present principles.

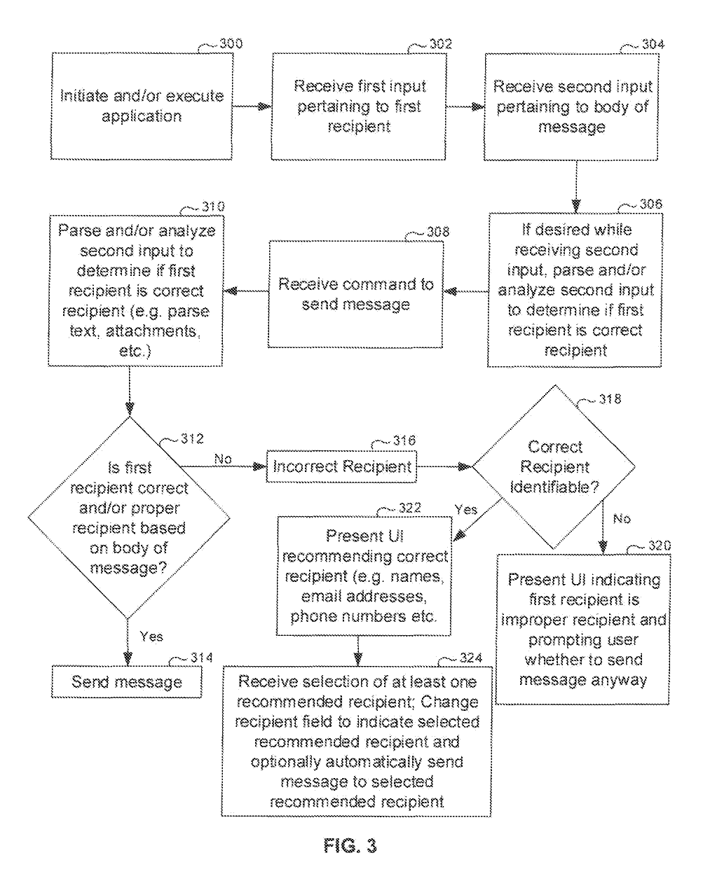

Referring to FIG. 3, it shows example logic that may be undertaken by a device such as the system 100 (referred to below as the “present device”) in accordance with present principles. Beginning at block 300, the logic initiates and/or executes an application for undertaking present principles, for composing a message using a messaging application such as email application, instant messaging application, or text messaging application, and/or e.g. for interfacing with such a messaging application to undertake present principles. From block 300 the logic moves to block 302 where the logic receives first input pertaining to at least a first recipient to which a message is to be sent (e.g. input to a recipient field of a message composition user interface (UI)). The logic then proceeds to block 304 at which the logic receives second input pertaining to the body of the message (e.g. the body and/or pay load of the message, such as text which is to form part of the body and/or an attachment to be sent with the message such as an image (e.g. photograph) or word processing document).

After block 304 the logic proceeds to block 306, at winch the logic may optionally (e.g. based on settings established by a user) and while receiving the second input parse and/or analyze the text as it is being received to determine based at least in part on the first and second input whether the first recipient is a correct, proper, and/or appropriate recipient as will be further set forth below. Thereafter, the logic proceeds to block 308, at which the logic receives a command (e.g. from a user based on selection of a send selector element from the message composition UI) to send the message being composed. The logic then proceeds to block 310, where the logic parses and/or analyzes the text automatically without further user input (e.g. using text recognition) in response to receipt of the send command to determine based at least in part on the first and second input whether the first recipient is a correct, proper, and/or appropriate recipient.

Still in reference to FIG. 3, after block 310 the logic moves to decision diamond 312. At diamond 312, the logic determines based at least in part on the parsing and/or analyzing executed at block 310 whether the first recipient is a correct and/or proper recipient based on e.g. the body of the message (e.g. text forming at least a portion of the body and/or an attachment to the message). Responsive to an affirmative determination at diamond 312, the logic moves to block 314 at which the logic sends the message based on the command. However, responsive to a negative determination at diamond 312, the logic instead moves to block 316, where the logic concludes that the first recipient is an incorrect recipient and then moves to decision diamond 318.

At diamond 318 the logic determines whether a correct recipient for the message is identifiable, as will be further set forth below. In any case, a negative determination at diamond 318 causes the logic to proceed to block 320 where the logic presents a user interface (UI) indicating that the first recipient is an improper recipient and prompting a user to provide input regarding whether to send the message to the first recipient anyway.

Referring hack to diamond 318, should the logic instead make an affirmative determination thereat, the logic instead proceeds from diamond 318 to block 322. At block 322, the logic presents a UI recommending at least one correct recipient as identified by the present device. Examples of recipients include e.g. names, email addresses, phone numbers, etc. Regardless, after block 322 the logic moves to block 324 where the logic receives selection from a user of at least one of the recommended correct recipients. In response to receipt of the selection, the logic may do one or both of changing a recipient field of the message composition UI to indicate the recommended correct recipient associated with the selection rather than the first recipient, and/or automatically without further user input send the message to the recommended correct recipient associated with the selection.

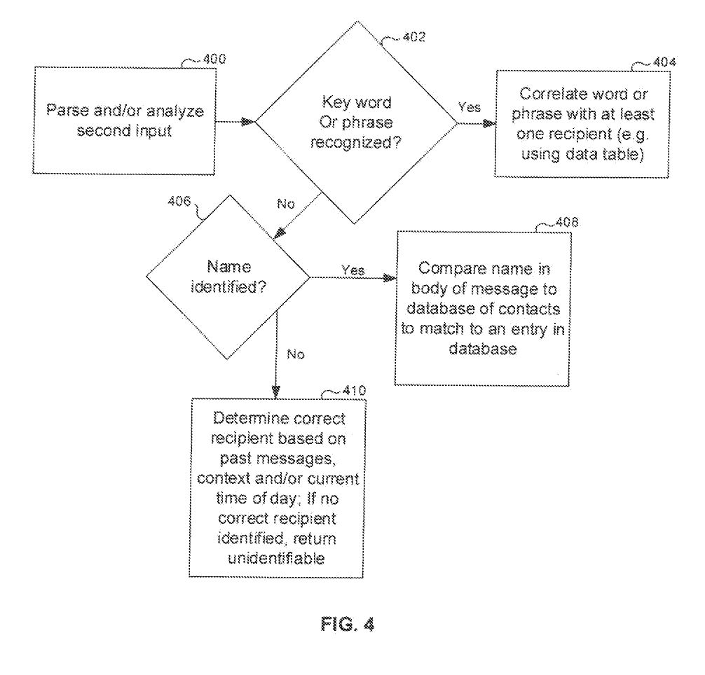

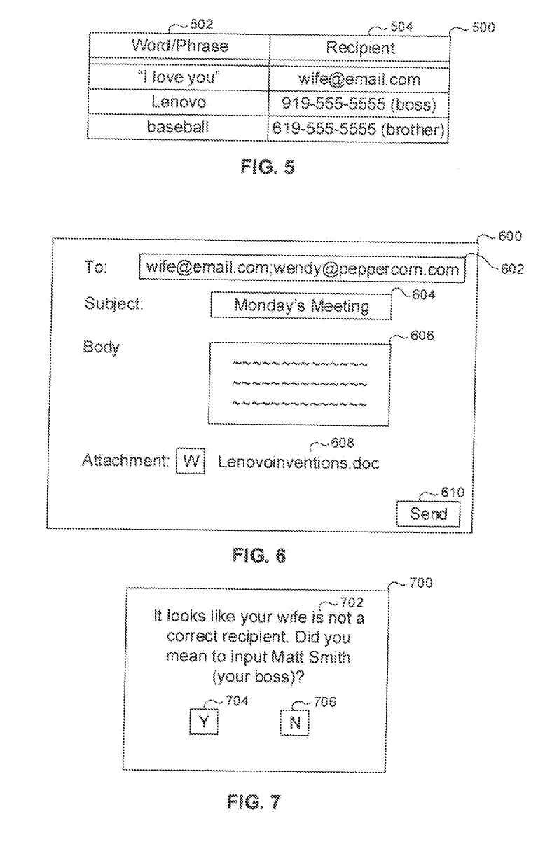

Now in reference to FIG. 4, it shows example logic that may be undertaken by a device such as the system 100 (referred to below as the “present device”) in accordance with present principles, it being understood that the logic of FIG. 4 may be executed in conjunction with the logic of FIG. 3. Beginning at block 400, the logic parses and/or analyzes the second input described above in reference to FIG. 3 (e.g. text comprising at least a portion of a body of a message). The logic then proceeds to decision diamond 402, where the logic determines whether a key word or phrase from the second input is recognized and/or identified. E.g. the logic may access a data table correlating key words and phrases with recipients to match at least one word or phrase from the second input to a word or phrase in the data table (e.g. an example of such a data table will be described below in reference to FIG. 5). An affirmative determination at diamond 402 causes the logic to proceed to block 404, where the logic correlates the word or phrase with at least one recipient. Using the data table example described immediately above, e.g. should a match of a word or phrase from the second input be made to an entry in the data table for the word or phrase, the logic may identify the match and access data in the table associated with the entry for which the match was identified to identify a corresponding and/or associated recipient for the entry. Thereafter, in some embodiments, from block 404 the logic may e.g. proceed to undertake an action such as that set forth above in reference to block 322 of FIG. 3.

Referring back to decision diamond 402, if instead a negative determination is made thereat, the logic proceeds to decision diamond 406. At diamond 406 the logic determines whether a name has been identified from the second input (e.g. the user typed a name) based on the parsing and/or analyzing. An affirmative determination causes the logic to move to block 408, where the logic compares the name from the body of the message to e.g. a database and/or list of contacts to (e.g. at least attempt to) identify a contact from the database which matches the name in the body of the message. Responsive to identifying at least one contact in the database, the logic may identify e.g. a destination associated with the contact in the database (e.g. an email address, instant message screen name, and/or phone number) to use as a correct recipient in accordance with present principles (e.g. to recommend on a UI, using one or both of the name for which a match has been identified and the destination itself a correct recipient). Thus, in some embodiments, from block 408 the logic may e.g. proceed to undertake an action such as that set forth above in reference to block 322 of FIG. 3.

Referring back to diamond 406, should a negative determination be made thereat, the logic proceeds to block 410. At block 410, the logic may determine whether the first recipient is a correct recipient, and/or actually identify a correct recipient, based on one or more of past messages (e.g. sent by the user, from the present device, and/or from an account associated with the message composition UI (e.g. email account)), message context (e.g. context identified from the body of the message), and/or a current time of day. With more detail, the logic may determine a correct recipient based on past messages by e.g. identifying commonalities between the message being composed and the past message(s) to make an association based thereon, and then identify a recipient of the past message which may then be used as a recommendation of a potential correct recipient for the message being composed (e.g. if not the same as the first recipient indicated by the user as set forth above in reference to FIG. 3). Commonalities may include e.g. a unique message signature, one or more words or phrases used in both the message being composed and the past message, salutations used, common topics and/or subjects that are identified (e.g. from the body of the message, and/or from the subject field), one or more recipients of the identified past message other man the first recipient (e.g. to thus recommend the other recipient as a correct recipient instead, such as where one of the other recipients is identified as being a recipient in both the past message and the message being composed while another of the other recipients is identified as being a recipient of the past message but not the message being composed), etc.

Providing some more detail on message context, words and/or phrases from the message being composed may be identified to thus determine a context for the message (e.g. a work message, a personal message, an appointment reminder, a message about a particular topic, etc.) and hence e.g. whether the first recipient described above is a correct recipient. Context associations may be made e.g. using data tables comprising a first column listing various contexts and a second listing associated recipients for the respective context entry (which may be e.g. dynamically created and changed over time by the device based on messages that are sent). Current time of day may also be used by e.g. identifying a current time of day and determining particular classes of messages that are typically sent at that time of day. E.g., work messages may be determined to typically be sent during business hours, while personal messages may be determined to typically be sent in evening hours. Thus, should the first recipient received from the user as described above in reference to FIG. 3 be a recipient for which messages are typically sent (e.g. at least a threshold amount of times and/or threshold percentage of total message transmissions) in evening hours and/or which the device determines to be a personal message recipient, but the current time of day when the message is being composed is a time during normal business hours, it may be determined that an incorrect recipient was provided by the user and hence that an alternate, correct recipient should be identified (e.g. a work recipient that is typically emailed at or around that current time of day).

Concluding the description of FIG. 4, in response to identifying and/or determining a correct recipient thereat, in some embodiments the logic may e.g. then proceed to undertake an action such as that set forth above in reference to block 322 of FIG. 3. Also note that at block 410, if no correct recipient is identified, the logic may provide an indication that no correct recipient is identifiable.

Referring now to FIG. 5, an example data table 500 is shown that correlates key words and/or phrases with particular recipients in accordance with present principles. The table 500 includes a first column 502 which comprises at least one entry of a word or phrase and a second column 504 which comprises at least one recipient (e.g. and optionally, plural recipients) associated with each respective entry from the column 502. Note that the entries in column 504 may include not only e.g. email addresses and phone numbers, but also e.g. respective descriptions of people with which the email addresses and/or phone numbers are associated.

Continuing the detailed description in reference to FIG. 6, an example message composition user interface (UI) 600 is shown. The UI 600 includes at least a recipient field 602 for entrance of one or more recipients of the message, a subject field 604 for entrance of a subject for the message, and a body/payload field 606 for entrance of test to form at least a portion of the body of the message. Also note that an attachment 608 is indicated in the present example as being attached to the message. A send selector element 610 is also shown which is selectable to cause the device presenting the UI 600 to parse e.g. the subject field 604 and body field 606 to determine a correct recipient in accordance with present principles and/or send the message being composed.

Turning to FIG. 7, it shows an example UI 700 including an indication 702 that, using the same example as in FIG. 6, the recipient “wife@email.com” with which the contact description “wife” is associated is not a correct recipient (e.g. as determined based on one or more identifications and/or determinations by the device in accordance with present principles). The indication 702 also prompts the user regarding whether another recipient named “Matt Smith” (who is indicated as the boss of the person with which the device presenting the UI 600 is associated) is the recipient whom the user meant to indicate as an intended recipient. Thus, a yes selector element 704 is shown which is selectable to automatically without further user input replace the recipient “wife@email.com” with a destination address associated with Matt Smith (e.g. automatically enter Matt Smith's destination address in place of “wife@email.com” in the field 602 described above, and/or automatically send the message to the destination address associated with Matt Smith without again presenting the UI 600). Also note that a no selector element 706 is shown, which is selectable to automatically without further user input leave “wife@email.com” as the recipient (e.g. decline to change “wife@email.com” in the field 602 to another recipient, and/or automatically send the message to “wife@email.com” without again presenting the UI 600). Before moving on, note that in some embodiments, the UI 700 may be presented e.g. when only a single correct recipient (e.g. “Matt Smith”) has been identified in accordance with present principles, while in other embodiments may be presented when “Matt Smith” is determined to be the most likely correct recipient (e.g. based on Matt Smith being identified as a correct recipient plural ways (e.g. based on a name in the body of the email and based on the current time of day) while other recipients may have been identified in only one way). Thus, e.g. in some embodiments a threshold number of characteristics for a match are to be reached prior to recommending an identified recipient as a correct recipient.

Referring now to FIG. 8, it shows an example UI 800 including an indication 802 that, using the same example as above, the recipient “wife@email.com” with which the contact description “wife” is associated is not a correct recipient (e.g. as determined based on one or more identifications and/or determinations by the device in accordance with present principles). The indication 802 also prompts a user regarding whether plural other potential correct recipients were meant to be entered by the user instead. Accordingly, selector elements 804, 806, and 808 are respectively associated with other recipients recommended by the device, and one or even plural of the elements 804-808 may be concurrently selectable to (e.g. automatically without further user input, and/or based on subsequent selection of the submit selector element 810) transmit the message to the respective recipients associated with the one or more selector elements 804-808 that are selected, and/or replace a recipient indicated by a user in a recipient input field (e.g. the field 602 described above) with the respective recipients associated with the one or more selector elements 804-808 that are selected.

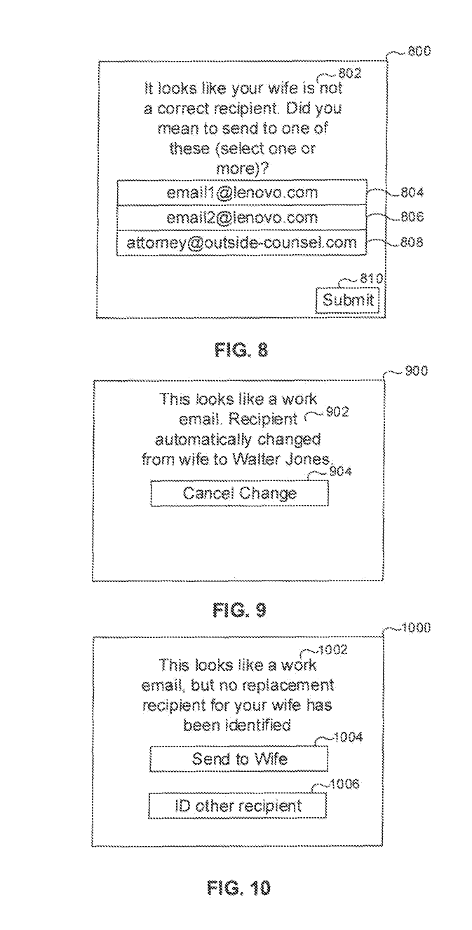

Now describing FIG. 9, it shows yet another example UI 900 that may be presented on a device in accordance with present principles. The UI 900 includes an indication 902 that the message being composed by a user appears to be a context-related email (e.g. in this case, the context being a work-related email). The indication 902 also indicates that the recipient has been automatically changed by the device (e.g. upon identification of a correct recipient) from the contact “wife” to “Walter Jones” with whom the work context is associated in this instance. Also note that a cancel change selector element 904 is shown which is selectable to automatically without further user input cancel the automatic change to Walter Jones made by the device and/or configure the device to continue to maintain “wife” as the recipient (e.g. in the field 602).

Referring to FIG. 10, it shows another example UI 1000 that may be presented on a device in accordance with present principles. The UI 1000 includes an indication 1002 that the message being composed by a user appears to be a context-related email (e.g. in this case, the context being a work-related email) but that a correct and/or replacement recipient for “wife” could not be identified. The UI 1000 thus includes a first selector element 1004 selectable to automatically without further user input one or both of transmit the message to wife regardless and/or configure the device to continue to maintain “wife” as the recipient (e.g. in the field 602). The UI 1000 also includes a second selector element 1006 selectable to automatically without former user input configure the device to e.g. present another UI and/or window from which a correct recipient may be selected (e.g. from a contact list) and automatically entered into the recipient input field in place of the “wife” recipient, while in other embodiments the second selector element 1006 is selectable to automatically without further user input configure the device to again present a message composition UI from which the message was composed and render the recipient field as the active field so that a user may subsequently enter another recipient (e.g. where the field upon return to the message composition UI does not present the “wife” recipient in the recipient field).

Accordingly, as may be appreciated from FIG. 11, the message composition UI 600 is again shown, but note in contrast to FIG. 6 that the recipient “wife@email.com” has been replaced with a destination associated with “Walter Jones” (e.g. automatically based on selection of a selector element as discussed above) while yet another recipient (“wendy@peffercom.com”) remains in the field 602 in FIG. 11 as previously (e.g. initially) input by the user as also shown in FIG. 6 (e.g. and based on “wendy@peffercom.com” being determined to be a correct recipient in accordance with present principles).

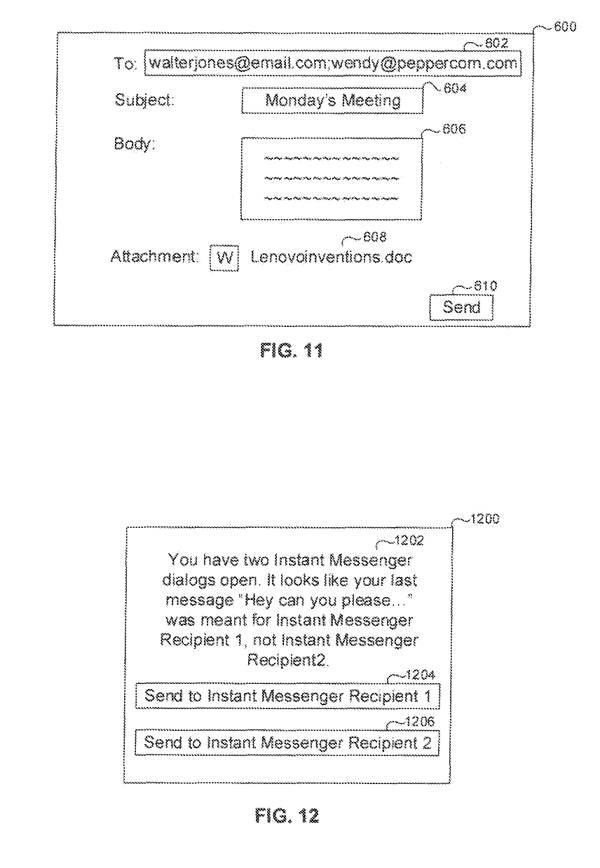

Continuing the detailed description now in reference to FIG. 12, it shows an example UI 1200 presentable on a device in accordance with present principles for recommending a correct recipient. FIG. 12 is understood to pertain to e.g. composition and transmission of instant messages (IM) where e.g. plural instant message dialogs, windows, and/or conversations are open concurrently. Thus, the UI 1200 includes an indication 1202 that e.g. two IM dialogs are open and that the last message that was input (e.g. at least a beginning of which and optionally the entire message is presented in the indication 1202) appears to have been meant to be entered into the other of the two dialogs to which it was actually entered, and/or appears to have been meant to be sent to the other of two recipients than the one to which it is currently set to be sent based on the dialog to which it was entered.

In addition to the indication 1202, the UI 1200 also includes one or more recommendations of recipients to which the message may be sent. Thus, a first selector element 1204 is shown which is selectable to automatically without further user input e.g. send the message to which the UI 1200 pertains to a correct recipient determined to be “IMRecipient1” and/or automatically remove the text at issue (“e.g. “Hey can you please . . . ”) from the dialog (e.g. specifically, a text entry field therein) between the device and “IMRecipient2” and instead present it in the dialog between the device and “IMRecipient1” (e.g. in a text entry field therein). Also note that a second selector element 1206 is shown which is selectable to automatically without further user input e.g. send the message to “IMRecipient2” anyway even if the device identified another potential correct recipient (e.g. in this case, “IMRecipient1”), and/or continue to present the text at issue in the dialog associated with “IMRecipient1.”

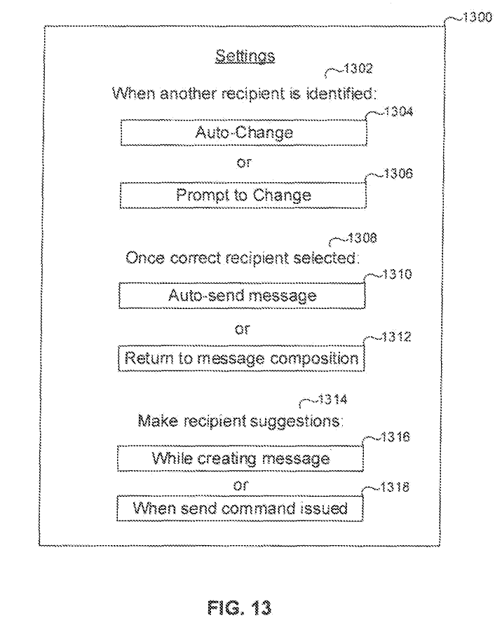

Before moving on to the description of FIG. 13, it is to be understood that depending on various factors (e.g. whether a correct recipient has been identified, and/or the number of correct recipients identified), a device undertaking present principles may dynamically determine which of the UIs 700, 800, 900, 1000, or 1200 may be presented.

Now in reference to FIG. 13, it shows an example settings UI 1300 for configuring settings of a device and/or application undertaking present principles. The UI 1300 includes a first setting 1302 pertaining to what the device/application (referred to below as the “device” for clarity) is to do when a correct recipient for a message is identified. The setting 1302 therefore includes a first selector element 1304 selectable to automatically without further user input configure the device to change the recipient to which a message is to be sent to the correct recipient identified by the device (e.g. input the correct recipient into a recipient input field in place of a user-provided recipient). The setting 1302 also includes a second selector element 1306 selectable to automatically without further user input configure the device to provide a prompt to a user regarding whether to change to the correct recipient (e.g., present a UI such as the UIs 700, 800, and/or 900 described above).

The UI 1300 of FIG. 13 may also include a second setting 1308 pertaining to what the device is to do responsive to a correct recipient recommendation being selected by a user (e.g., based on a recommendation as provided on a UI such as one of the UIs 700, 800, and/or 900 described above). Accordingly, the UI 1300 includes a first selector element 1310 that is selectable to automatically without further user input configure the device to send the message responsive to receipt of input selecting a recommended correct recipient, and the UI 1300 also includes a second selector element 1312 selectable to automatically without further user input configure the device to return to a message composition screen (e.g. the UI 600 described above) responsive to receipt of input selecting a recommended correct recipient.

Still in reference to FIG. 13, the UI 1300 may include yet another setting 1314 to configure the device to make correct recipient suggestions in accordance with present principles (e.g. present a UI such as one of the ones described above) e.g. concurrently while a message is being composed (e.g. the device thus parsing and/or analyzing input as it is received from a user) or responsive to receipt of a send command to transmit the message. Thus, FIG. 13 shows a selector element 1316 which is selectable to automatically without further user input configure the device to present correct recipient suggestions concurrently with the message being composed, and also shows a selector element 1318 which is selectable to automatically without further user input configure the device to present correct recipient suggestions responsive to receipt of a send command to transmit the message.

Without reference to any particular figure but in reference to the parsing and/or analyzing of attachments to messages as set forth above to determine a correct recipient, it is to be understood that if the attachment is e.g. a word processing document or another type of document containing text, both the payload and metadata of the attachment may be parsed and/or analyzed for data to use to determine a correct recipient. If the attachment is e.g. an image such as a “selfie,” the image may be parsed and/or analyzed to determine that the image is a “selfie” and hence an informal image rather than a professional one to thus determine that the image should not be transmitted to a professional (e.g. work-related) contact. Furthermore, facial recognition software may be used when analyzing an image to identify at least one person in the image and thus identify a correct recipient (e.g. contact from a contact, list also having respective images of the contacts to which the analyzed attachment image may be compared and matched) for the message based on the image. Thus, e.g., if the attachment image includes the face of a particular person, that particular person may be recommended as a correct recipient of the message.

Also without reference to any particular figure, it is to fee understood that identifying, determining, recommending, and/or automatically inputting a correct recipient (e.g. to a recipient field of a message composition UI) may be done in accordance with present principles even if e.g. the user does not first indicate a recipient such as one that may have been an unintended recipient. E.g., the user may skip inputting a recipient when composing a message (and in some instances, e.g. instead use a default recipient such as e.g. the person or device with whom the user and/or the user's device last communicated (e.g. using the same messaging application)). In such instances, whether no recipient is initially specified by the user or the user's device (e.g. for the device, one being specified as a “default” recipient), the device may nonetheless undertake present principles to determine a correct recipient.

It may now be appreciated that in at least one respect, present principles provide for parsing of a message before it is sent. Message context may be compared for applicability with historical messages to determine appropriateness for the current contact. If a recipient mismatch is detected, message context may also be compared with other contacts. Furthermore, time or message frequency (e.g. messages being sent to a particular recipient) may be used to determine when a message is being sent to a correct recipient. E.g., a recent dialog (e.g. one or more messages being transmitted back and forth between two devices) may be weighted more heavily when comparing conversation content.

What's more, concurrency may be used to determine when a user is more likely to send a message to the wrong person. E.g., if the user is texting multiple people at the same time, more concurrent recipients would change the threshold to identify an incorrect recipient. Further still, the message parsing may occur as the message is being entered, and/or before the message is sent.

In any case, when a recipient mismatch is detected, a user may be notified and if a different contact can be better matched to the message, the new contact is suggested as an alternate recipient. If the user agrees (e.g. as determined based on input to the device), the message is moved to the correct chosen recipient.

If there is ambiguity regarding which contact should be used, multiple alternate contact suggestions may be presented to the user. For multi-recipient messages (e.g. messages where the message is to be sent to plural recipients), individual contacts may be plucked out or replaced with correct recipients if only e.g. one contact of plural contacts is determined to be incorrect.

In instances where a message includes an attachment that is a document, text of both the message and the document may be compared for applicability. For pictures, the image may be processed to determine applicability for the given contact. For example, attaching a “selfie” in a message to a colleague would warn the user and potentially redirect the message to a proper contact.

As but one more example, suppose a message discusses a personal matter. The context of the message being a personal matter may be determined via a keyword(s) such as signs of affection (e.g. ‘I love you’), family names, terms of endearment (e.g. honey, sweetie), message tone (e.g. ‘you suck’), referencing specific subjects/topics, etc. A message recipient input by a user may then be determined to be incorrect e.g. based on a title for the recipient accessible to the device (e.g., steve@lenovo.com being indicated as a “boss”) and the identified personal matter context, and thus the text of the message may itself be moved to a different thread and/or message.

Before concluding, it is to be understood that although e.g. a software application for undertaking present principles may be vended with a device such as the system 100, present principles apply in instances where such an application is e.g. downloaded from a server to a device over a network such as the Internet. Furthermore, present principles apply in instances where e.g. such an application is included on a computer readable storage medium that is being vended and/or provided, where the computer readable storage medium is not a carrier wave and/or a signal per se.

While the particular DEVICES AND METHODS FOR DETERMINING A RECIPIENT FOR A MESSAGE is herein shown and described in detail, it is to be understood that the subject matter which is encompassed by the present application is limited only by the claims.

1. A device, comprising:
a processor;
a touch-enabled display accessible to the processor; and
storage accessible to the processor and bearing instructions executable by the processor to:
receive first input pertaining to at least a first recipient to which a message is to be sent;
receive second input pertaining to a body of the message;
parse at least a portion of the body of the message to determine, based on at least a portion of the body of the message, whether the first recipient is a correct recipient for the message; and
present, on the touch-enabled display, a first user interface (UI) comprising an option to: configure the device to automatically change message recipients if a message recipient indicated by a user is determined to be an incorrect recipient or configure the device to present a prompt on the touch-enabled display for the user to provide input to change message recipients if the message recipient indicated by the user is determined to be an incorrect recipient.

2. The device of claim 1, wherein the instructions are further executable to:
determine, based on at least a portion of the body of the message, that the first recipient is not a correct recipient for the message; and
recommend a correct recipient for the message.

3. The device of claim 2, wherein the instructions are executable to:
present a second user interface (UI) on the touch-enabled display which presents at least one recommendation of a correct recipient for the message, the second UI being manipulable to select a recommendation of the at least one recommendation.

4. The device of claim 3, wherein the instructions are executable to:
in response to receipt of third input corresponding to a selection of a first recommendation from the second UI and without further input from a user, change a destination to which the message is to be sent from the first recipient to a second recipient different from the first recipient.

5. The device of claim 4, wherein data pertaining to the destination is presented in a recipient held of a third UI for composing the message.

6-7. (canceled)

8. The device of claim 1, wherein the instructions are executable to determine a correct recipient based at least in part on:
identification from the body of the message of one of the group consisting of: a word, a phrase; and
correlation of the one of word and phrase with at least one particular recipient.

9. The device of claim 8, wherein the correlation is made at least in part based on data in a data table accessible to the device, the data table correlating at least one of words and phrases with particular recipients.

10-13. (canceled)

14. The device of claim 1, wherein the instructions are executable to determine a correct recipient based at least in part on a current time of day.

15. A method, comprising:
analyzing at least a portion of a pay load of a message which is at least partially composed at a device to determine at least one recipient at least in part by pursing an attachment to the message, the message composed at least in part using a first user interface (UI) presented on a display of the device; and
based at least in part on the analysis, recommending the at least one recipient.

16. (canceled)

17. The method of claim 15, wherein the payload is analyzed as the payload is composed.

18. The method of claim 15, where the method comprises recommending the at least one recipient at least in part by presenting a second UI on the display comprising at least a first selector element associated with a first recipient, the first selector element being selectable to without further user input insert the first recipient into a field of the first UI associated with a destination of the message.

19. An apparatus, comprising:
a first processor;
a network adapter;
storage bearing instructions executable by a second processor for:
determining, based on at least a portion of a body of a message, whether a first recipient of the message is a proper recipient for the message, the first recipient received from a user, the determining whether the first recipient is a proper recipient at least in part being based on data accessible using the second processor;
in response to determining that the first recipient is not a proper recipient, inserting a second recipient into a recipient field of the message automatically without additional user input related to a message recipient, the second recipient being different from the first recipient;
wherein the first processor transfers the instructions over a network via the network adapter.

20. The apparatus of claim 19, wherein the instructions are further executable for:
in response to determining that the first recipient is not a proper recipient and a failure by the second processor to identify at least one proper recipient presenting a window on a display indicating that the first recipient has been determined to be an improper recipient.

21. The device of claim 1, wherein the UI is a UI manipulable for configuring settings for composing and transmitting messages.

22. The device of claim 1, wherein the UI is a first UI, and wherein the first UI comprises an option to: automatically without further user input send a message upon user selection of a correct recipient or return to a second UI for message composition upon user selection of a correct recipient.

23. The device of claim 1, wherein the UI comprises an option for the device to: make suggestions of correct recipients while messages are being composed or make suggestions of correct recipients responsive to receipt of commands to transmit messages.

24. The method of claim 15, comprising:
parsing metadata associated with the attachment to at least attempt to recommend the at least one recipient.

25. The method of claim 15, wherein the attachment is an image.

26. The method of claim 25, comprising:
executing facial recognition software to identify at least one person from the image;
identifying at least one person from the image based at least in part on execution of the facial recognition software; and
recommending the at least one recipient based at least in part on identification of the at least one person from the image.

27. The apparatus of claim 19, wherein the instructions are executable by the second processor for:
in response to determining that the first recipient is not a proper recipient, inserting the second recipient into the recipient field of the message automatically without presenting a prompt for the user to select a proper recipient.
